(19) United States
(12) Patent Application Publication
(10) Pub. No.: US 2012/0310694 A1
(43) Pub. Date: Dec. 6, 2012

(54) Enhancements To Executable Guideline Engines

(75) Inventors: Kees Van Zon, Cold Springs, NY (US); William P. Lord, Fishkill, NY (US)

(73) Assignee: KONINKLIJKE PHILIPS ELECTRONICS N.V., EINDHOVEN (NL)

(21) Appl. No.: 13/511,205

(22) PCT Filed: Nov. 17, 2010
(86) PCT No.: PCT/IB2010/055241

§ 371 Date: May 22, 2012

Related U.S. Application Data
(60) Provisional application No. 61/285,203, filed on Dec. 10, 2009.

(51) Int. Cl. G06Q 10/06

(52) U.S. Cl. 705/7.15

(57) ABSTRACT

A system and method for loading and displaying a guideline graph based on a first user input, receiving a second user input selecting a desired portion of the guideline graph and processing the second user input to load and display a sub-graph including the desired portion of the guideline graph.

### BACKGROUND

There are many causes of medical errors, inconsistent care, sub-optimal care and prolonged duration of care. For example, medical errors and inefficiencies may result from information overload, overcrowding/understaffing, lack of readily available specialists and the rapidly growing knowledge base in medicine. Evidence suggests that many medical errors and inefficiencies in healthcare can be avoided by standardizing clinical care through guidelines and protocols. Thus, clinical guidelines documenting a set of evidence-based recommendations for healthcare professionals on how to optimally diagnose, treat and manage patients have been developed by various medical professional organizations. Typically the recommendations by these organizations are not intended to be rigid rules, but rather are meant to be pieces of evidence to guide their users.

Efforts have been made to computerize clinical guidelines and protocols since electronic versions are preferable to paper versions given the advantages of exchanging information easily and reliably with a hospital information system. Languages that specify computer-interpretable guidelines (e.g., Asbru, EON, GLIF, New Guide, PRODIGY and PROforma) are interpreted by guideline execution engines (e.g. GLEE and Gaston) that interpret the computer-interpretable guideline languages. Conventional guideline execution engines, however, restrict clinical users to a prescribed order of events. In order to overcome this limitation, case handling or work flow management systems (e.g., FLOWER, ECHO, the Staffware Case Handler, the COSA Activity Manager) may be utilized.

Electronic guideline management systems, however, still have a number of limitations. The guidelines may be long, requiring a great deal of user navigation and making it difficult for a user to determine which tasks have been completed by other users. Additionally, the computerized guideline may not indicate which tasks should be completed together and whether a task should be completed within a certain amount of time.

### SUMMARY OF THE INVENTION

A method for loading and displaying a guideline graph based on a first user input, receiving a second user input selecting a desired portion of the guideline graph and processing the second user input to load and display a sub-graph including the desired portion of the guideline graph.

A system having a user interface to enter a first and a second user input, a memory, a processor loading the guideline graph from the memory based on the first user input and a sub-graph based on the second user input, which selects a portion of the guideline graph that a user desires to view in the sub-graph and a display displaying the guideline graph and the sub-graph.

A computer-readable storage medium including a set of instructions executable by a processor. The set of instructions being operable to load and display a guideline graph based on a first user input, receive a second user input selecting a desired portion of the guideline graph and process the second user input to load and display a sub-graph including the desired portion of the guideline graph.

### BRIEF DESCRIPTION OF THE DRAWINGS

FIG. 1 shows a schematic diagram of a system according to an exemplary embodiment.

FIG. 2 shows a flow diagram of a method according to the system of FIG. 1.

FIG. 3 shows an exemplary screen shot of an electronic guideline of a patient who is experiencing stroke symptoms.

### DETAILED DESCRIPTION

The exemplary embodiments may be further understood with reference to the following description and the appended drawings wherein like elements are referred to with the same reference numerals. The exemplary embodiments relate to a system and method for displaying a guideline graph of tasks associated with a particular disease. In particular, the exemplary embodiments provide a system and method for displaying sub-graphs of the disease guideline graph based on, for example, a portion of the guideline graph desired to be viewed by a user and/or a particular user type. The guideline graph and the sub-graph include nodes corresponding to tasks associated with the disease and may indicate, for example, a status of the tasks and/or a time requirement for a particular task. The sub-graphs may overlap such that a completion of a task by one user will reflect in a sub-graph for another user. It will be understood by those of skill in the art that although the exemplary embodiments describe guidelines for the management of acute stroke, the following systems and methods may be applied to guidelines for any disease. It will also be understood by those of skill in the art that the following systems and methods may be applicable outside of the medical domain to display a graphical representation of tasks based on any accepted guideline, workflow, or protocol.

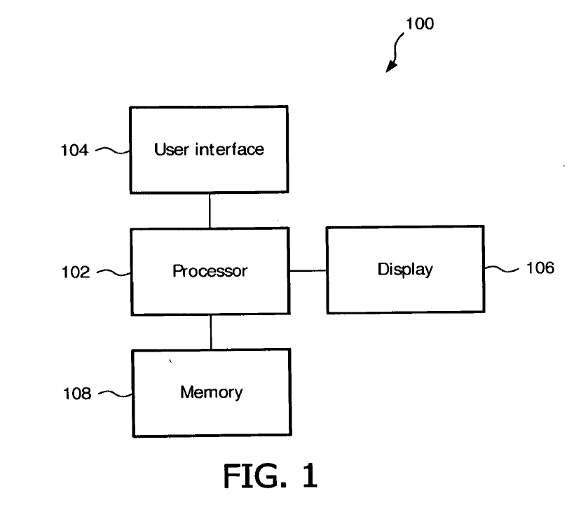

As shown in FIG. 1, a system 100 according to an exemplary embodiment loads and displays a guideline graph or sub-graph based upon user input indicating a particular disease. The guideline graph includes nodes, each of the nodes representing a task from an industry-accepted clinical guideline, a clinical care protocol, and/or a clinical workflow. Particular nodes of the guideline graph or sub-graph may be selected to load and display another sub-graph for a particular group of tasks and/or a particular user. The system 100 comprises a processor 102 that is capable of processing user inputs entered via a user interface 104 to load and display a guideline graph or sub-graph for a particular disease. Subsequent user inputs may include, for example, opening another guideline graph or sub-graph. The system 100 further comprises a display 106 for displaying the guideline graph or sub-graph. The displayed guideline graph or sub-graph is loaded from a memory 108, which includes a database storing the computerized representations of industry-accepted guidelines, protocols and/or workflows. The memory 108 also stores guideline sub-graphs that have been updated with patient-specific information. The user interface 104 may include a mouse to point and click on items on the display 106, a touch display and/or a keyboard. The memory 108 may be any known type of computer-readable storage medium. It will be understood by those of skill in the art that the system 100 is, for example, a personal computer, a server, or any other processing arrangement.

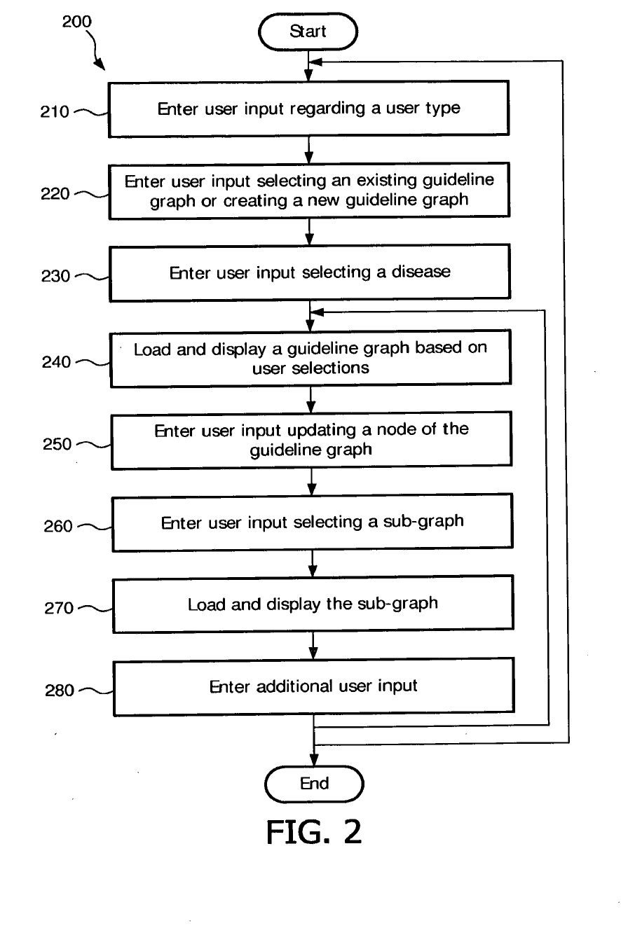

FIG. 2 shows a method 200 according to an exemplary embodiment, in which the system 100 permits a user to select portions of a guideline graph to display in a sub-graph. The method 200 includes selecting a user type (e.g., nurse, specialist, administrator) via the user interface 104 to view a user-specific guideline sub-graph. A user-specific guideline sub-graph shows, for example, only those nodes and/or tasks for which the particular user is responsible. Once the user type has been selected in a step 210, a default guideline graph or sub-graph is automatically opened for this user. The user now elects to either open an existing patient case, showing a status thereof in the guideline graph or sub-graph, or create a new patient case, showing an initial status in the guideline graph or sub-graph, in a step 220.

The user now selects a disease from any number of disease guideline graphs or sub-graphs stored in the memory 108 such as, for example, acute stroke, cardiac arrest, etc., in a step 230. The user may select the disease via direct election of a disease or by following a guideline graph or sub-graph for patient triage and/or differential diagnosis to help lead the user to the selection of the correct disease guideline graph or sub-graph. The disease guideline graphs and sub-graphs are a graphical representation of particular tasks associated with each disease. The tasks correspond to tasks recommended in industry-accepted guidelines, protocols and workflows. It will be understood by those of skill in the art, however, that the step 230 will only be required if the system 100 supports multiple diseases. It will also be understood by those of skill in the art that the user may also elect not to select a particular user type to view a guideline graph or sub-graph that is disease-specific only.

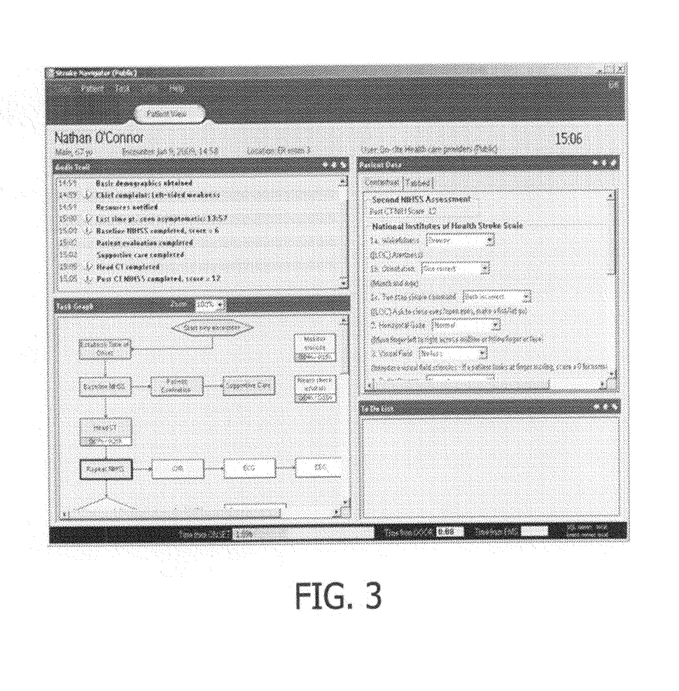

In a step 240, the guideline graph or sub-graph selected by the user, which is disease and/or user specific, is loaded and displayed on the display 106. The guideline graph or sub-graph is displayed, as shown in FIG. 3, with the tasks displayed as nodes in the guideline graph or sub-graph. The nodes may be connected to one another via arrows indicating a desired order of the tasks associated with each of the nodes. Tasks of the guideline graph or sub-graph that are not required to precede and/or follow other tasks of the guideline graph are indicated by a free-floating node, without any arrows pointing to and/or from other nodes. The display 106 may also show other information such as, for example, patient data, an audit trail and a To-Do list.

In a step 250, the user updates a node (e.g., task) of the displayed guideline graph or sub-graph to, for example, indicate a status of the class, enter additional patient data and/or make a decision required by the task. It will be understood by those of skill in the art that the step 250 is repeated as desired by the user, until all available patient data has been entered. Visual indications may be used to indicate properties of a node such as, for example, a status of a task of a particular node and an active node. For example, a node may change color to indicate that the task has been completed. A change in color of only a portion of the node may indicate that the task has been partially completed. The active node (e.g., the node of the task currently being reviewed and/or updated) may be indicated via a bold border surrounding the node. Once the task of an active node has been completed, the following node(s) in the guideline graph or sub-graph automatically becomes the active node. It will be understood by those of skill in the art, however, that the user may also select a particular node to activate that node.

Since the system 100 may have various users whose responsibilities may overlap, guideline graphs and sub-graphs may overlap depending on selections made by various users. The various users may utilize the system 100 from different workstations on a network. To permit overlap and synchronization between guideline graphs and sub-graphs viewed on the same or different workstations, each node of the guideline graph or sub-graph includes two classes, a workflow step and a graph node. The workflow step corresponds to the task of the node such that the task is displayed in multiple guideline graphs and sub-graphs, sharing properties of the node. For example, updating a node (e.g., entering additional information, indicating a completion of the task) in one sub-graph will correspondingly change the status of the same node (i.e., task) in all other guideline graphs and sub-graphs as well. The workflow step of the node may also have an associated timer for tasks that require attention within a predetermined amount of time. For example, the guideline may require that a Head CT be conducted within 25 minutes of a patient's arrival. The timer tracks an elapsed time and/or an amount of time remaining until the predetermined amount of time expires. The graph node class is a graph-specific instantiation of the workflow step, representing graph-specific properties such as, node text, location, size, shape and color.

The displayed timer node shows both graphically and textually how much time has elapsed from the predetermined amount of time and/or the amount of time remaining until the task is due. For example, the graphical portion of the timer node may show a bar, moving in a given direction as time elapses. Separate colors may be used to show the time elapsed and the time remaining. The displayed timer nodes may also be edited. For example, the user selects the timer node to change a predetermined amount of time that a task must be completed in, change a visual and/or textual representation of the timer, etc. For guideline graphs in which a timer node is displayed, a visual and/or audible alert is generated, once the. predetermined amount of time has elapsed and the task has not been completed. In another embodiment, the visual and/or audible alert may be generated a predefined amount of time before and/or after the predetermined amount of time has expired. In addition, the alert may be generated at given intervals until a task is completed.

Visible alerts include a flashing timer node, a pop-up window showing the overdue node, etc. The timer node may flash in certain colors depending on the status of the task. For example, the timer node flashing red indicates that the task is overdue. In another embodiment, the timer node flashes green to indicate that the task needs to be repeated at given intervals. Audible alerts include beeps, rings, etc. It will be understood that any of a variety of audible and/or visible alerts may be generated by the processor 102 so long as the alerts sufficiently notify the user regarding the status of the task.

In some clinical situations, the guideline graph may be very large, requiring the user to scroll through a large portion of the guideline graph to view a desired portion of the guideline graph. In one exemplary embodiment, portions of the guideline graph that are viewable as sub-graphs are visually indicated. For example, some of the nodes of the guideline graph may be formed of a different shape, (e.g., hexagon), size, color or font type to indicate that a sub-graph is associated with that particular node of the guideline graph. It will be understood by those of skill in the art that the visual indications corresponding to the various properties of the node will be predetermined.

In the step 260, the user enters input regarding a user viewing preference via the user interface 104. The user elects to view a portion of the guideline graph, via a sub-graph, by selecting a particular node of the guideline graph, indicating the portion of the guideline graph that the user desires to view. Alternatively, the user may elect to view another sub-graph of the current guideline, or another guideline, or a sub-graph of another guideline. Thus, the user will select a, for example, hexagonally shaped node to view a sub-graph associated with the desired portion of the guideline graph, or another guideline graph, or a sub-graph of another guideline. Since user input may be entered for other reasons (e.g., to enter patient data for a particular task, or to indicate a completion of a task), a predetermined mode of input for selecting guideline graphs or sub-graphs may be stored. For example, the user may double-click on the hexagonally shaped node to view the associated sub-graph and single click on a node to open a form for entering data associated with the node. It will be understood by those of skill in the art, however, that the mode of input may be selected and determined for various types of user input, as desired. Based on the user input entered in step 260, the processor 102 loads and displays a guideline graph or sub-graph from the memory 108, in a step 270, which displays a portion of the nodes included in the guideline graph or sub-graph. The display 106 may also display the corresponding timer node for any nodes of the sub-graph that require attention within the predetermined amount of time. The displayed guideline graph or sub-graph may be either read-only, providing an overview of the tasks from that guideline graph and sub-graph, or writable, meaning that the user may update and/or edit the nodes of the sub-graph via, for example, entering additional info, changing the status of a node, etc. The guideline graph or sub-graph may be viewed in a separate window on the display 106 or may be viewed in an existing window, in a separate frame of the window.

In the step 280, the user enters additional input. The additional input may either elect a different system option or update one of the nodes of the guideline graph or sub-graph. For example, the user may elect to select a different guideline graph or sub-graph node to view a different guideline graph or sub-graph, select a different user-type, update a node to change a status of the task, enter additional patient information, make a decision, etc. Where the additional user input indicates a desire to view a different guideline graph or sub-graph, the method 200 may return to the step 240. It will be understood by those of skill in the art, however, that a variety of other user inputs and associated system responses are also possible. For example, the guideline graph and sub-graphs updated with patient information, user preferences and other user input may be stored in the memory 108 in a patient file and recalled, as desired by the user. Once the status of the currently displayed guideline graph/sub-graph has been stored in the memory 108 and the guideline graph or sub-graph has been closed, the method 200 may revert to the step 210 so that another new or existing guideline graph or sub-graph may be selected.

It will be apparent to those skilled in the art that various modifications may be made to the disclosed exemplary embodiments and methods and alternatives without departing from the spirit or the scope of the disclosure. Thus, it is intended that the present disclosure cover modifications and variations provided that they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A method, comprising:
loading and displaying (240) a guideline graph based on a first user input;
receiving (260) a second user input selecting a desired portion of the guideline graph; and
processing the second user input to load and display (270) a sub-graph including the desired portion of the guideline graph.

2. The method of claim 1, wherein the guideline graph and the sub-graph include a plurality of nodes, each of the nodes representing a task to be completed by a user.

3. The method of claim 2, wherein each of the nodes is represented by at least a workflow step class and a graph node class, wherein the workflow step class represents shared properties of the node such that all nodes overlap and are synchronized between all guideline graphs and sub-graphs viewable over a network, and wherein the graph node class represents graph-specific properties.

4. The method of claim 2, wherein a portion of the plurality of nodes includes a visual feature to indicate one of (i) portions of the guideline graph that are viewable as a sub-graph and (ii) a status of a node, the status of the node being one of a level of completion of a task.

5. The method of claim 4, wherein the visual feature includes one of a shape, a size, a color and a font type.

6. The method of claim 1, wherein the first user input indicates at least one of a user type and a disease.

7. The method of claim 1, further comprising:
receiving (250, 280) a third user input including one of an information to update one of the guideline graph and the sub-graph and a selection of another viewing option.

8. The method of claim 1, further comprising:
determining a time remaining before a task from the sub-graph should be completed and a time elapsed since a patient event and displaying one of the time remaining and the time elapsed in a timer node.

9. The method of claim 8, further comprising:
generating an alert alerting a user that the task is due to be completed.

10. The method of claim 8, wherein the timer node includes a bar graph showing the time remaining and the time elapsed.

11. The method of claim 2, wherein each of the nodes is one of connected to another node via an arrow to indicate an order of the tasks and free-floating to indicate that the task is not required to precede and follow another task.

12. A system, comprising:
a user interface (104) to enter a first and a second user input;
a memory (108);
a processor (102) loading the guideline graph from the memory (108) based on the first user input and a sub-graph based on the second user input, which selects a portion of the guideline graph that a user desires to view in the sub-graph; and
a display (106) displaying the guideline graph and the sub-graph.

13. The system of claim 12, wherein the guideline graph and the sub-graph include a plurality of nodes, each of the nodes representing a task to be completed by a user.

14. The system of claim 13, wherein each of the nodes is represented by at least a workflow step class and a graph node class, wherein the workflow step class represents shared properties of the node such that all nodes overlap and are synchronized between all guideline graphs and sub-graphs viewable over a network, and wherein the graph node class represents graph-specific properties.

15. The system of claim 13, wherein a portion of the plurality of nodes includes a visual feature to indicate one of (i) portions of the guideline graph that are viewable as a sub-graph and (ii) a status of a node, the status of the node being one of a level of completion of a task.

16. The system of claim 15, wherein the visual feature includes one of a shape, a size, a color and a font type.

17. The system of claim 12, wherein the first user input indicates at least one of a user type and a disease.

18. The system of claim 12, wherein a third user input is entered via the user interface, the third user input including one of an information to update one of the guideline graph and the sub-graph and a selection of another viewing option.

19. The system of claim 12, wherein the processor (102) determines a time remaining before a task from the sub-graph should be completed and a time elapsed since a patient event and displaying one of the time remaining and the time elapsed in a timer node.

20. The system of claim 19, wherein the processor (102) generates an alert alerting a user that the task is due to be completed.

21. The system of claim 19, wherein the timer node includes a bar graph showing the time remaining and the time elapsed.

22. The system of claim 13, wherein each of the nodes is one of connected to another node via an arrow to indicate an order of the tasks and free-floating to indicate that the task is not required to precede and follow another task.

23. A computer-readable storage medium (106) including a set of instructions executable by a processor (102), the set of instructions operable to:
load and display (240) a guideline graph based on a first user input;
receive (260) a second user input selecting a desired portion of the guideline graph; and
process the second user input to load and display (270) a sub-graph including the desired portion of the guideline graph.
